(19) United States
(12) Patent Application Publication
(10) Pub. No.: US 2005/0245374 A1
(43) Pub. Date: Nov. 3, 2005

(54) Apparatus for applying additive to filter tow

(75) Inventors: Steffen Rocktaschel, Brietlingen (DE); Gerd Strohecker, Marschacht (DE)

Correspondence Address: VENABLE LLP, P.O. BOX 34385, WASHINGTON, DC, 20045-9998, US

(73) Assignee: Hauni Maschinenbau AG, Hamburg (DE)

(21) Appl. No.: 11/103,440

(22) Filed: Apr. 12, 2005

(30) Foreign Application Priority Data
Apr. 30, 2004 (DE) 10 2004 021 773.4

(51) Int. Cl. B31C 13/00

(52) U.S. Cl. 493/39

(57) ABSTRACT

An apparatus for applying an additive to a moving, spread-out web of filter tow in the tobacco-processing industry includes an application element for applying the additive to the spread-out web of filter tow. At least one scraper element is positioned transverse to a direction of movement of the filter tow and includes a sliding surface aligned substantially parallel to the filter tow movement direction.

### CROSS-REFERENCE TO RELATED APPLICATION

This application claims the priority of German Patent Application No. 10 2004 021 773.4, filed on Apr. 30, 2004. The disclosures of the foregoing priority application and of each U.S. and foreign patent and patent application mentioned below are incorporated herein by reference.

### BACKGROUND OF THE INVENTION

The invention relates to an apparatus for applying a preferably liquid additive to a moving, spread-out web of filter tow in the tobacco-processing industry by an application element. The invention furthermore relates to the use of a scraper element.

For filter-rod production in the tobacco-processing industry, filter tow which primarily consists of cellulose acetate is pulled in the form of an endless web from a supply and is then treated. The filter tow consists of a gauze of loosely adhering filaments which are pulled apart to form a wide and substantially flat web, so that the filaments move side-by-side and substantially parallel to each other. The web is spread out inside a spreader nozzle. Following this, a finely dispersed additive which is generally in liquid form, for example consisting of droplets of triacetin, is applied to the spread-out web. The droplets cause the filaments to partially dissolve, so that the filaments permanently adhere to each other, meaning they are interlaced, after they are gathered to form a circular rod which is wrapped with filter paper inside a filter-rod maker.

A finely dispersed, pulverized substance can also be used in place of the liquid additive. Processing machines of the aforementioned type have already been described in U.S. Pat. Nos. 5,060,664 and 4,511,420.

German patent document DE-A-199 59 034 discloses the spraying of filter tow with plasticizer by a row of nozzles positioned transverse to the filter-tow movement direction. The individual nozzles in that case are controlled by means of upstream installed sensors that detect the filter-tow density in the corresponding sections.

Extremely important to the processing quality are a good separation of the individual fibers or filaments and/or a uniform application of the finely-distributed plasticizer particles in the form of droplets or fine particles.

### SUMMARY OF THE INVENTION

Starting with the aforementioned prior art, it is an object of the present invention to ensure a uniform distribution of a plasticizer on the filter tow to improve the quality of the filter production.

The above and other objects are accomplished according to the invention by the provision of an apparatus for applying an additive to a moving, spread-out web of filter tow in the tobacco-processing industry, comprising: an application element for applying the liquid additive to the spread-out web of filter tow; and at least one scraper element positioned transverse to a direction of movement of the filter tow and including a sliding surface aligned substantially parallel to the filter tow movement direction.

With presently known scraper blades, for example those used in an apparatus for spraying triacetin onto filter tow, larger amounts of plasticizer can deposit at undesirable locations on the scraper blade. The primary advantage of the scraper element according to the invention, which is provided with the sliding surface and/or guiding surface, is that the filter tow is guided on the scraper element as a result of the extended sliding surface for the filter tow and that no dead zones for the accumulation of plasticizer droplets can form on the scraper element. In contrast, the constant accumulation of droplets in the dead zones of prior art scrapers permits a larger amount of plasticizer to accumulate which is then carried along by the moving filter tow once a specified amount and/or size is reached. The lumps of material carried along create undesirable holes in the acetate section of a finished filter due to the higher concentration of plasticizer in the filter tow and/or the acetate tow web. By purposely eliminating dead zones where plasticizer droplets can accumulate, the formation of holes in a filter, caused by larger plasticizer lumps, can thus be reduced considerably.

To achieve a more uniform plasticizer application and even distribution of the plasticizer inside the filter through the elimination of dead zones on the scraper blade respectively the scraper element, it is advantageous if the sliding surface on the scraper element is embodied as a flat bar, especially extending over the complete width of the spread-out filter tow.

The sliding surface is shaped to include a channel in which plasticizer that is not absorbed by the filter tow can accumulate and from which it is subsequently removed.

According to one preferred embodiment of the invention, the scraper element is designed to have a nearly L-shaped, T-shaped, or U-shaped cross section, wherein a section of the element is preferably designed as a sliding surface for the scraper element and is arranged to extend substantially or nearly parallel to the movement direction of the filter tow.

In particular, the scraper element is shaped to define a channel, for example, for discharging to the side the triacetin plasticizer which has collected in the channel above the conveyed filter tow and into a collection basin for plasticizer materials.

It is furthermore advantageous if the scraper element position can be adjusted inside the apparatus.

The apparatus is furthermore and advantageously enclosed completely by a housing, inside of which the additive is applied to the spread-out filter tow.

The object is also achieved by a method of applying an additive to a moving, spread-out web of filter tow in the tobacco-processing industry, comprising utilizing an apparatus for applying an additive to a moving, spread-out web of filter tow in the tobacco-processing industry, wherein the apparatus includes an application element to apply the additive to the filter tow, and a scraper element positioned transverse to the filter-material movement direction having a sliding surface extending substantially parallel to the filter-material movement direction.

Advantageous embodiments of the scraper element according to the invention follow from the above explanations to which we expressly refer.

### BRIEF DESCRIPTION OF THE DRAWINGS

Without restricting the general inventive idea, the invention is explained in the following with the aid of exemplary embodiments and with reference to the drawings to which reference is expressly made for all details not explained further in the text.

FIG. 1 shows an enlarged cross-sectional view of a scraper blade according to the prior art.

FIGS. 2a, 2b show separate enlarged cross sectional views through a scraper blade according to the invention.

FIG. 3A is a cross-sectional view of a spraying apparatus with scraper blade.

### DETAILED DESCRIPTION OF THE PREFERRED EMBODIMENTS

Respectively the same or similar elements and/or parts are provided with the same reference number in the following Figures and will not be introduced again.

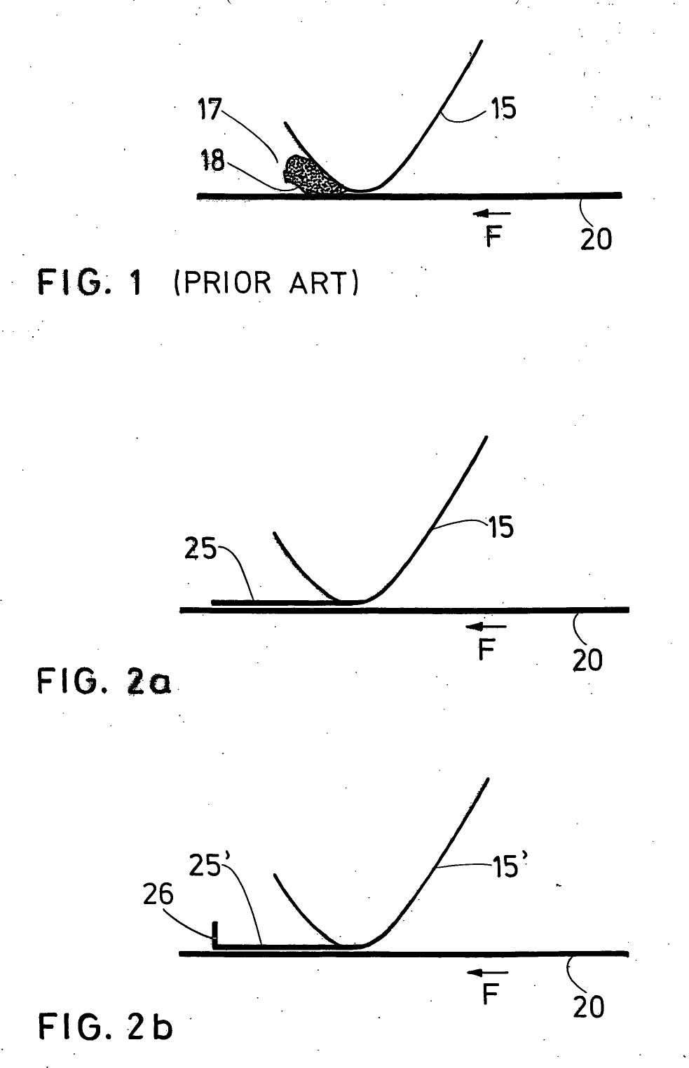

FIG. 1 shows a cross-sectional enlarged detail view of an apparatus for applying an additive, such as a plasticizer, to a filter tow, wherein the apparatus is provided with a known scraper blade 15. The scraper blade 15 has a hook-shaped and/or V-shaped and/or parabolic design. The spread-out filter tow 20 is conveyed past underneath the scraper blade 15, in a conveying direction F shown herein. In the process, the filter tow 20 and the scraper blade 15 make contact at the lowest point of scraper blade 15.

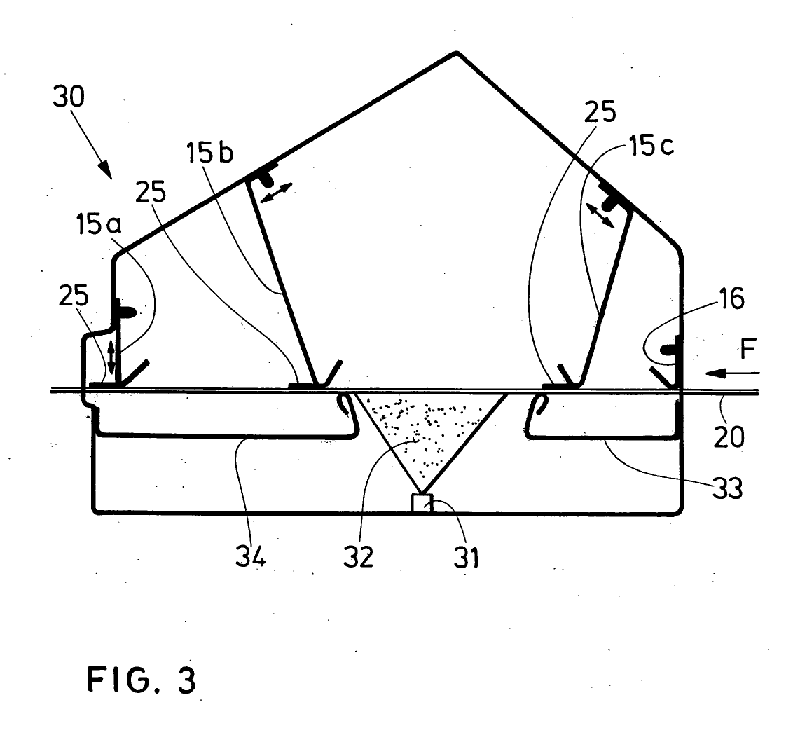

The triacetin is applied in the form of triacetin droplets to the filter tow 20, for example by means of an application nozzle or an applicator brush that is not shown herein. Owing to the volatility of the triacetin droplets, the atmosphere in the spraying apparatus (FIG. 3) is enriched with triacetin droplets.

The tangential contact between the filter tow 20 and the lowest point on the scraper blade 15 creates in the contact region a dead zone 17, in the conveying direction of the filter tow 20, in which triacetin droplets can collect. A lump 18 of triacetin forms which is carried and/or pulled along by the filter tow 20 only after reaching a predetermined size and/or amount.

FIG. 2a shows a cross section through a scraper blade 15 according to the invention which is provided at the lowest point with a horizontal sliding surface 25 and is arranged parallel to the spread-out surface of the filter tow 20. The horizontal extension of the sliding surface 25 thus eliminates the dead zone 17 shown in FIG. 1.

The level sliding surface 25 functions as a guide for the filter tow 20, across the complete width of the filter tow 20. The sliding surface 25 furthermore functions as spoiler, meaning that at production speeds the filter tow 20 is pulled slightly against the underside of the sliding surface 25, so that the deposited triacetin is continuously scraped off the sliding surface 25 by the tow 20, thus preventing the accumulation of larger amounts of triacetin droplets in the dead zone 17 depicted in FIG. 1.

FIG. 2b shows a cross section through a different scraper blade 15′ according to the invention, for which a sliding surface 25′ is provided with a perpendicular wall 26 which delimits the end of sliding surface 25′. As a result of this perpendicular wall 26, the sliding surface 251 forms a type of channel in which plasticizer that is not absorbed by the filter material and/or filter tow or excess plasticizer can accumulate and from which it can be removed.

FIG. 3 shows a schematic, cross-sectional view of an apparatus 30 for applying a plasticizer, e.g. triacetin, to the spread-out filter tow 20. The filter tow 20 is transported from right to left as shown in conveying direction F. An application nozzle 31 is disposed in the lower region of apparatus 30, wherein this nozzle generates a spray cone 32 of triacetin plasticizer droplets. The application nozzle 31 generates a fine, atomized spray of a plasticizer, e.g. the triacetin, for the application.

The filter tow 20 is guided through the apparatus 30 by lower scraper blades 33, 34, wherein these lower scraper blades 33, 34 are disposed in the lower region of apparatus 30. Three scraper blades 15a, 15b and 15c are positioned above the filter tow 20 and are provided with a sliding surface 25 which is aligned approximately parallel to the filter tow 20 movement direction. The scraper blades 15a, 15b and 15c are adjustable in their positions by moving the blades along the inner walls of the housing. After positioning the blades 15a, 15b and 15c are fixed by a srew or the like. In addition, a different scraper blade 16 is arranged above the filter tow 20 in the region where the filter tow 20 enters the apparatus 30. This scraper blade is not provided with a sliding surface since it is far removed from the location where plasticizer is applied to the filter tow 20 inside the apparatus 30.

The scraper blades 15a, 15b and 15c have either a U-shaped or V-shaped cross section in the region of the filter tow, which results in an indentation defining a channel or basin. A T-shaped cross section is also possible. The plasticizer droplets that fly around or run off the housing walls collect inside the indentation in the upper region of the apparatus and are discharged to the side, above the filter tow 20.

It will be understood that the above description of the present invention is susceptible to various modifications, changes and adaptations, and the same are intended to be comprehended within the meaning and range of equivalents of the appended claims.

1. An apparatus for applying an additive to a moving, spread-out web of filter tow in the tobacco-processing industry, comprising:
an application element for applying the additive to the spread-out web of filter tow; and
at least one scraper element positioned transverse to a direction of movement of the filter tow and including a sliding surface aligned substantially parallel to the filter tow movement direction.

2. The apparatus according to claim 1, wherein the sliding surface of the scraper element comprises a flat bar which extends across a complete width of the spread-out filter tow.

3. The apparatus according to claim 1, wherein the sliding surface is shaped to define a channel.

4. The apparatus according to claim 1, wherein the scraper element has a cross section having one of a nearly L-shape, T-shape or U-shape.

5. The apparatus according to claim 1, wherein the scraper element is shaped to define a channel that extends transverse to the filter tow movement direction.

6. The apparatus according to claim 1, wherein the scraper element is adjustable in its position.

7. The apparatus according to claim 1, further including a housing enclosing the application element and the at least one scraper element.

8. A method of applying an additive to a moving, spread-out web of filter tow in the tobacco-processing industry, comprising utilizing the apparatus according to claim 1.

9. The method according to claim 8, wherein the sliding surface of the scraper element comprises a flat bar extending over a complete width of the spread-out filter tow.

10. The method according to claim 8, wherein the sliding surface is shaped to define a channel.

11. The method according to claim 8, wherein the scraper element has a cross section having one of a nearly L-shape, T-shape or U-shape.

12. The method according claim 8, wherein the scraper element is shaped to define a channel which extends transverse to the filter tow movement direction.

13. The method according claim 8, including adjusting a position of the scraper element.
